(19) United States
(12) Patent Application Publication
(10) Pub. No.: US 2010/0288147 A1
(43) Pub. Date: Nov. 18, 2010

(54) PRINT CYLINDER WITH RUBBER BLANKET FOR A ROTARY OFFSET PRINTING PRESS

(75) Inventor: Stefan Beyersdorff, Steinen (DE)

Correspondence Address: VENABLE LLP, P.O. BOX 34385, WASHINGTON, DC, 20043-9998, US

(73) Assignee: Mueller Martini Holding AG, Hergiswil (CH)

(21) Appl. No.: 12/782,334

(22) Filed: May 18, 2010

(30) Foreign Application Priority Data
May 18, 2009 (EP) 09160532.9

(51) Int. Cl. B41F 27/06

(52) U.S. Cl. 101/378

(57) ABSTRACT

An apparatus for a rotary offset printing press includes a print cylinder having a radially inward extending groove and a rubber blanket having a main section coupled to the print cylinder. The rubber blanket includes at least first, second and third layers in the main section. The first layer is a self-adhering layer which faces the print cylinder and is adapted to attach the rubber blanket to the print cylinder. The second and third layers are a support layer and a cover layer, respectively, which both face away from the print cylinder. The rubber blanket has a leading end section, as seen in a production direction of the print cylinder, and a trailing end section, as seen in the production direction of the print cylinder. The end sections directly adjoin the main section and at least the leading end section of the rubber blanket is inserted into the groove of the print cylinder.

### CROSS-REFERENCE TO RELATED APPLICATION

This application claims the priority of the European Patent Application No. 09160532.9, filed on May 18, 2009, the subject matter of which is incorporated herein by reference.

### BACKGROUND OF THE INVENTION

The invention relates to a print cylinder with a rubber blanket for a rotary offset printing press. Rotary offset printing presses use print cylinders embodied as rubber blanket print cylinders which are provided, for example, with a special fabric coated with rubber, the so-called rubber blanket.

The rubber blanket is an important link in the offset printing operation which functions to transfer the image and text information from the printing plate to the material for printing (paper or foils). The quality of a printing image is influenced, for example, by the composition of the materials used (fabric and type of rubber) and is also influenced decisively by the condition of the rubber blanket surfaces.

A rough distinction can generally be made between non-compressible rubber blankets and compressible rubber blankets, the so-called air-cushion blankets.

Conventional, non-compressible rubber blankets are composed of a base fabric layer and one or more additional layers of fabric and intermediate layers (reinforcing layers), as well as the actual rubber layer having a thickness of approximately 0.4 mm to 0.6 mm. The conventionally configured rubber blanket is nearly non-compressible, but can be deformed. Radial stresses consequently lead to a tangential displacement of the rubber material and the therewith associated forming of a bulge.

Non-conventional, compressible rubber blankets, also called air-cushion blankets, are composed of a base layer of fabric, an intermediate fabric layer with air enclosures, and a rubber cover layer. The air enclosures are embedded in the form of microscopic air bubbles or air channels, thus resulting in a deformability of the rubber blanket as a whole. The bulge forming that occurs with conventional rubber blankets can be avoided in this case owing to the compression of the intermediate fabric layer while, at the same time, the wear and tear on the printing form is also reduced.

These types of conventional or non-conventional rubber blankets, meaning rubber blankets composed of layers, are normally fitted onto, wrapped around or glued to the print cylinders. The invention described in the following relates to a print cylinder with self-adhering rubber blankets.

Self-adhering rubber blankets, as disclosed in the art, are glued to the print cylinder and do not require an additional attachment to the print cylinder. The rubber blanket is provided for this with a flat self-adhering layer for gluing it to the print cylinder. The problem, however, is a joining location where the ends of the rubber blanket abut or where the ends of the rubber blanket at least are positioned opposite each other.

Such joining locations are sealed with various types of sealing agents to prevent cleaning agents and printing ink from entering. The edges of the rubber blanket at the joining locations are damaged by grinding or milling prior to the sealing operation. With sealing operations of this type, there is a need to optimally shorten the hardening period for the sealing agent and thus shorten the waiting period until the next use of the print cylinder provided with the rubber blanket. A further problem is that despite the sealing operation, cleaning agents and/or printing ink can enter between the ends of the glued-on rubber blanket and, in particular, can result in separating the self-adhering layer.

### SUMMARY

An object of the present invention is to solve the aforementioned problems with self-adhering blankets at the joining location, such that the self-adhering layer between rubber blanket and print cylinder is reliably protected to prevent solvents or printing ink from entering. In addition, this location should present the smallest possible attack surface for a rubber blanket washing system. The size of the non-printing strip may also be taken into consideration to avoid exceeding a pre-determined joining location width, for example, but not limited to approximately 3 mm.

The above and other objects are accomplished according to one aspect of the invention wherein there is provided an apparatus for a rotary offset printing press which, in one embodiment, includes a print cylinder having a radially inward extending groove; and a rubber blanket having a main section coupled to the print cylinder, the rubber blanket comprising at least first, second and third layers in the main section, the first layer comprising a self-adhering layer which faces the print cylinder and is adapted to attach the rubber blanket to the print cylinder, and the second and third layers comprising a support layer and a cover layer, respectively, which both face away from the print cylinder, wherein the rubber blanket has a leading end section as seen in a production direction of the print cylinder and a trailing end section as seen in the production direction of the print cylinder, wherein the end sections directly adjoin the main section, and

wherein at least the leading end section of the rubber blanket is inserted into the groove of the print cylinder.

According to one embodiment, the main section extends over the total effective length of the rubber blanket which corresponds approximately to the circumference of the print cylinder. The main section may be adjoined by a leading end section as well as a trailing end section of the rubber blanket, in production direction of the print cylinder.

According another embodiment, the print cylinder is provided in at least one location along the circumference, radially on the outside, with a radially inward extending channel into which at least the leading end section of the rubber blanket is inserted. The channel may take the form of an axial groove in the surface area of the print cylinder. This groove may be normally open on the front side; alternatively, closed grooves are also possible. The groove furthermore need not extend in the axial direction, but can also extend at an angle.

According to a further embodiment, the trailing end section of the rubber blanket may adhere on one side of the joining location to the outer surface of the print cylinder, without being inserted into the channel. During the operation of the rotary offset printing press, the trailing end may be pressed against the print cylinder which acts counter to an undesirable separating.

According to one embodiment, the leading end section as well as the trailing end section of the rubber blanket may be inserted into the groove. Providing a groove, which is very unusual in itself for generic self-adhering rubber blankets, for inserting at least one end section of the rubber blanket into this radially inward directed groove on the print cylinder may protect the self-adhering layer between the rubber blanket and the print cylinder, thereby avoiding any type of sealing problems along a joining location. The leading end section or both end sections of the rubber blanket may be positioned, radially angled toward the inside, against each other inside the groove, either indirectly or directly parallel to each other.

According to another embodiment, the self-adhering layer may end at the radially outer edge of this groove, but may also end in the groove itself or may extend over the complete length of the rubber blanket. In either case, the self-adhering layer may be protected in at least one end section by the rubber blanket itself.

According to a further embodiment, the leading end section and/or the trailing end section may contain a reduced number of layers as compared to the main section. The thinner end sections, as compared to the main section, may thus be inserted easier into the groove. Above all, the reduction in the thickness itself is advantageous for an uncomplicated insertion into a narrow groove. As a result, extremely narrow, non-printing strips of the rubber blanket, respectively the print cylinder can be achieved.

According to one embodiment, at least one end section of the rubber blanked may contain an insertion aid. This insertion aid may be arranged in the form of a reinforcing layer on one side of the respective end section. The insertion aid may be constructed from metal, plastic or ceramic material.

In another embodiment, one or both end sections may be inserted into the groove. This can prevent an unintended sliding of the end sections from the groove.

According to a further embodiment, the insertion aid can be embodied as a reinforcing layer on one side of the rubber blanket. It is conceivable in that case to embody the fabric layer thicker or saturated with a special plastic material to stiffen an end section. However, the end sections or the layers of the end sections can also be composed of metal, plastic or ceramic materials. Corresponding layers can also be applied later on to the end sections to be inserted into the groove. Insertion aids of this type last a particularly long time and are cost effective, depending on the requirements.

According to one embodiment, the leading and/or the trailing end section is provided with a gliding layer, wherein this gliding layer may be applied permanently to the end section. One example of the gliding layer is a coating of polytetrafluorethylene or another substance having gliding properties. Gliding layers of this type make it easier to insert the respective end section since the friction between the groove wall and the rubber blanket is reduced. Whether a permanently applied gliding layer is selected or a gliding layer that is applied separately for each application, e.g. consisting of fats, alcohol or also a mixture of hydrocarbons (benzene, Vaseline), depends on the type of use of the respective print cylinder.

According to one embodiment, at least one of the rubber blanket layers may be removed in at least one end section. In this embodiment, the rubber blankets can be produced continuously and so that the end sections can be reworked during the finishing work. As a result of the layered configuration, for example, it offers itself to remove one or a plurality of outer layers by making a cut, so that the layer sections to be removed can be pulled off from the cutting location toward the end.

According to another embodiment, the at least one removed layer includes the self-adhering layer or a plurality of layers on the side facing the print cylinder.

According to a further embodiment, when cutting the blanket cylinder on the side facing the print cylinder or otherwise removing rubber blanket layers on the side facing the print cylinder, the remaining cover layer of the rubber blanket may extend into the groove. This surface consequently is not damaged at any location and continues to remain robust.

According to one embodiment, the at least one removed layer may comprise one or a plurality of the rubber blanket layers on the side facing away from the print cylinder.

According to a further embodiment, the removal of radially outer layers of the rubber blanket can be an advantage, depending on the thickness and rigidity of the cover layer. For example, if the cover layer is especially thick or rigid, then the non-printing strip can be embodied particularly narrow if the cover layer is removed in the end sections.

According to one embodiment, the at least one end section may be secured inside the groove, such that it can be detached. For example, the end section of the rubber blanket may be secured with the aid of elastic deformation, wherein the groove is embodied with slightly smaller dimensions as compared to the end section to be inserted. An uncomplicated fastening of one or both ends sections inside the groove is thus possible and, in many cases, meets the requirements for a secure operation of the rotary offset printing press. A rubber blanket secured in this way can furthermore be easily detached for a replacement, simply by pulling off the rubber blanket in radial direction toward the outside.

According to another embodiment, a strip may be arranged adjacent to one of the end sections or, alternatively, between the end sections of the rubber blanket. Alternatively, the strip may be fixedly connected to the rubber blanket as insertion aid and can thus be inserted together with the end section of the rubber blanket into the groove, where the strip can furthermore be embodied separate from the rubber blanket.

According to one embodiment, after both end sections of the rubber blanket have been inserted into the groove, for example, the strip can be pushed from the outside between the two end sections, so that the print cylinder is securely sealed toward the outside and solvents or printing ink cannot penetrate. Strips of this type can also be provided between the groove wall and the inserted end section, resulting in an elastic deformation of the end section of the rubber blanket which securely seals the print cylinder toward the outside and ensures that the end sections are fixated securely inside the groove.

According to a further embodiment, at least one spring element may be arranged inside the groove, adjacent to the at least one of the end sections of the rubber blanket. As an alternative, one wall of the groove can also be embodied to be resilient. The goal for this embodiment is again to achieve an elastic deformation of the at least one end section, where spring elements represent a particularly cost-effective solution to this problem.

According to an additional embodiment, the groove may be arranged parallel to the print cylinder axis in radial inward direction. Its center plane consequently may also extend radially toward the inside. However, it is not necessary for the center plane to extend precisely in radial direction. According to one advantageous embodiment, the center plane may be positioned at an angle, relative to the radial plane, which intersects the circumference of the print cylinder jointly with the center plane of the groove. For example, the leading end section can be inserted at an acute angle while the trailing end section is subsequently inserted at an obtuse angle.

In general, the above-described print cylinders are suitable for use with rotary offset printing presses.

### BRIEF DESCRIPTION OF THE DRAWINGS

The present invention will be more readily understood from the following detailed description when read in conjunction with the accompanying drawings, in which:

FIG. 1 is a detail of a radial section through a print cylinder, with a strip inserted into the groove between the end sections of the rubber blanket, according to an embodiment of the invention;

FIG. 2 is a representation according to FIG. 1, wherein only one end section of the rubber blanket is embodied and inserted into the groove;

FIG. 3 is a detail from a radial section through a print cylinder with a strip arranged between the groove and one end section, according to an embodiment of the invention;

FIG. 4 is a detail from a radial section through a print cylinder that is comparable to the print cylinder shown in FIG. 3, wherein the groove is provided with a spring element;

FIG. 5 is a detail from a radial section through a print cylinder for which the end sections are inserted into the groove, wherein radially outer layers of the rubber blanket are removed in one case and radially inner layers are removed in the other case, according to an embodiment of the invention;

FIG. 6 is a representation according to FIG. 5, but with the radially outer layer of the rubber blanket removed from both end sections inserted into the groove;

FIG. 7 is detail from a radial section through a print cylinder with a groove extending radially inward at an angle, according to an embodiment of the invention; and

FIG. 8 is a complete radial section through a print cylinder, provided with a groove that corresponds to the grooves shown in FIGS. 1 to 6.

### DETAILED DESCRIPTION

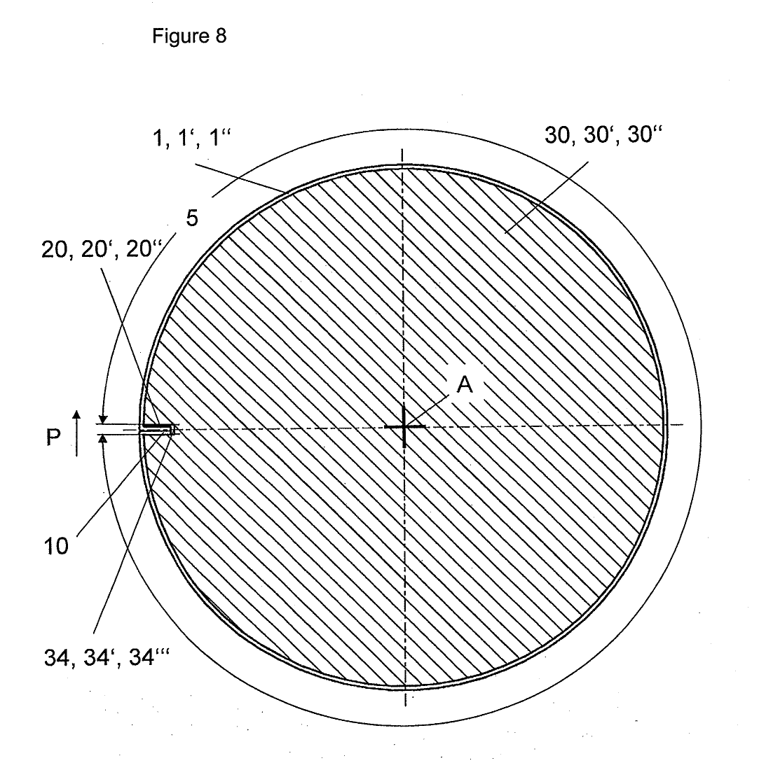

FIG. 8 shows a view of a complete radial section through a print cylinder 30, 30′, 30″, provided with a rubber blanket 1, 1′, 1″ and used with a rotary offset printing press. An axis A extends through the center of the print cylinder 30, 30′, 30″. An inward directed groove 34, 34′, 34″ that extends parallel to the axis A is provided on the circumference of the print cylinder 30, 30′, 30″. Inserted into the groove 34, 34′, 34″ are two end sections 10, 20, 20′, 20″ of the rubber blanket 1, 1′, 1″ which is attached over the complete circumference of the print cylinder 30, 30′, 30″, wherein the first end section 10 is a leading end section as seen in production direction P of the print cylinder 30, 30′, 30″ and the second end section 20, 20′, 20″ is embodied as a trailing end section. A main section 5 of the rubber blanket 1, 1′, 1″ extends over nearly the total circumference of the print cylinder 30, 30′, 30″ between the end sections 10, 20, 20′ and 20″ and is joined by the end sections 10, 20, 20′, 20″.

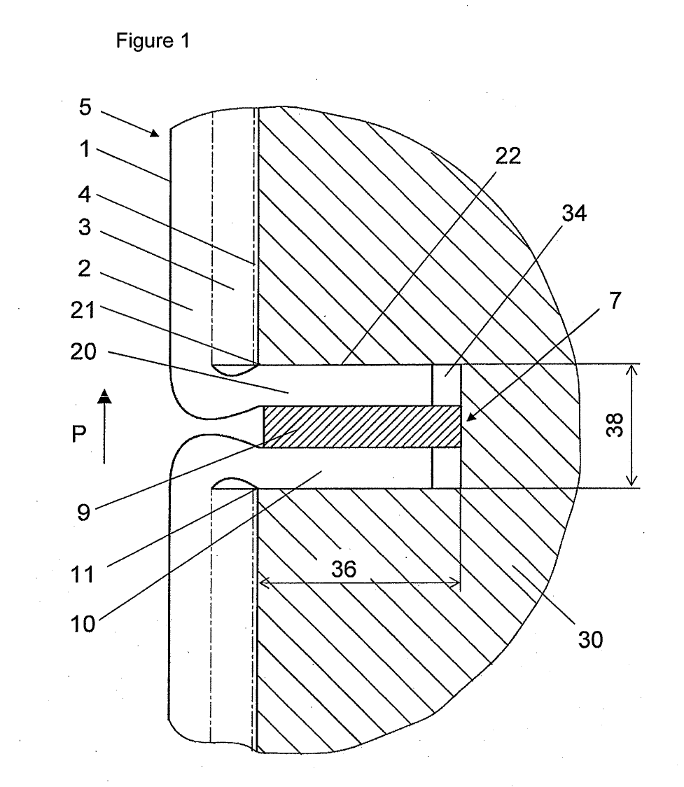

A first embodiment is shown in FIG. 1, which is also part of the total view according to FIG. 8. A detail from the radial section through the print cylinder 30 shows an enlarged view of the region surrounding the groove 34.

The groove 34 has a groove depth 36 and a groove width 38. These dimensions define a groove in the outer surface of the print cylinder 30 which holds the end sections 10, of the rubber blanket 1.

The rubber blanket 1 comprises a plurality of layers, meaning it is configured with a plurality of layers 2, 3, 4 as seen in radial direction, wherein each of the layers has a special function. Not shown are further layers which may exist and are disclosed in the art. In a radial inward direction a self-adhering layer 4 of the rubber blanket 1 is glued to the print cylinder 30, on the side facing the print cylinder 30. A support layer 3 which generally consists of a fabric follows in a radial outward direction. The rubber blanket 1 is provided radially on the outside with a cover layer 2 that faces away from the print cylinder 30. The cover layer 2 meets the respective surface criteria for generating a clean print image on the printing material, which is not shown herein.

The same layer configuration exists over nearly the complete circumference of the rubber blanket 1, meaning in the main section 5. The self-adhering layer 4 and the support layer 3 have been removed from the end sections 10, 20, starting from the outside edges 11, 21 of the groove 34 in the radial direction toward the inside. As a result, the end sections 10, 20 of first embodiment of the rubber blanket 1 are inserted only with a reduced thickness, namely the thickness of the cover layer 2, into the groove 34.

Following the insertion of the end sections 10, 20, an insertion aid 7 that is embodied as strip 9 is inserted in radial direction into the groove 34, between the end sections 10, 20 of the rubber blanket 1. In the circumferential direction, the end sections 10, 20 are clamped into the groove 34 as a result of the strip 9 being thicker as compared to the groove width 38. The end sections 10, 20 in this case are elastically deformed. The insertion aid 7 can alternatively also be embodied as reinforcing layer on one side of the respective end section 10, 20, wherein this layer can consist of metal, plastic or ceramic material.

The arrangement according to the first embodiment successfully results in a complete sealing of the self-adhering layer 4 toward the outside. The end sections 10, of the rubber blanket 1, which are inserted into the groove 34, are inserted into, pushed into, or fitted into the groove 34 around the radially outer edges 11, 21 and are additionally fixated by the strip 9 inside the groove 34. The dimensions of the groove 34 are smaller, relative to the inserted end sections 10, 20 and the strip 9, so that the end sections 10, 20 are clamped into the groove 34 without requiring additional devices, thereby resulting in creating a secure seal toward the outside.

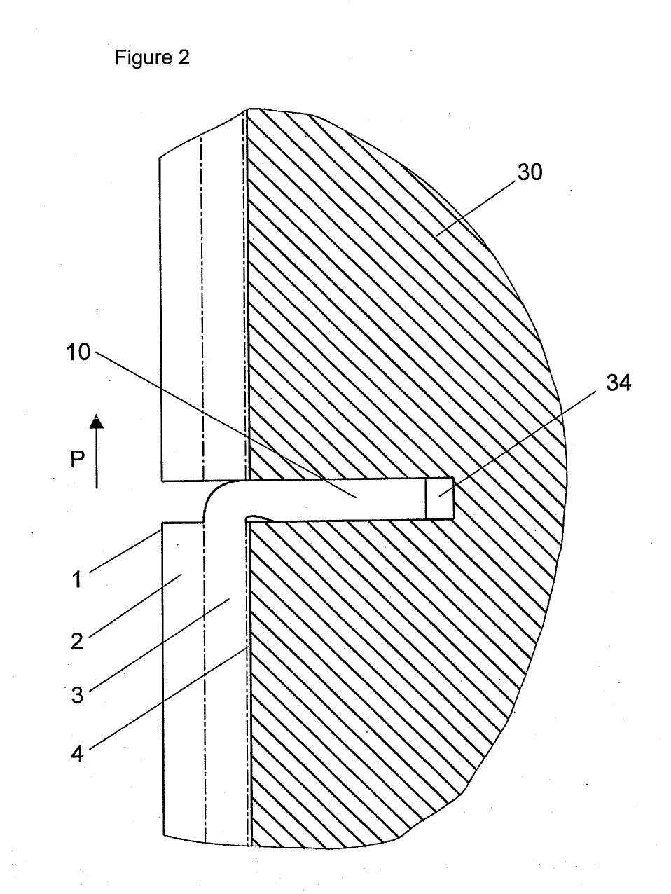

For the second example shown in FIG. 2, the rubber blanket 1 is embodied with only one end section, the leading end section 10, which inserted into the groove 34. As a result, it is possible to realize a narrower groove 34 and thus also a narrower non-printing strip of the rubber blanket and/or the print cylinder 30. In addition, the rubber blanket 1 can be finished easier in this way, meaning the rubber blanket 1 only needs to be cut to the desired length.

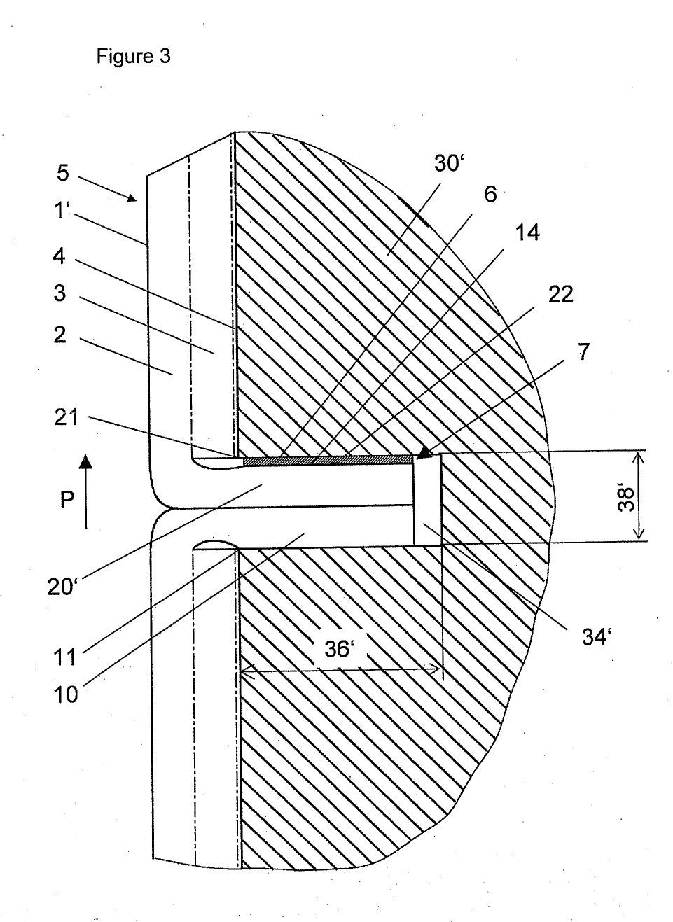

FIG. 3 contains a third embodiment which again shows a detail of a radial section through the print cylinder 30′ with glued-on rubber blanket 1′, comparable to the representation in FIG. 1. The print cylinder 30′ is also provided with a groove 34′ that is comparable to the groove according to FIG. 1, having a groove thickness 38′ and a groove depth 36′.

In the same way as for the representation in FIG. 1, a cut is made to the rubber blanket 1′ on the side facing the print cylinder 30′ at the level of the radially outer edges 11, 21 of the groove 34′. The self-adhering layer 4 and the support layer 3 for the second embodiment are again pulled off for the respective end sections 10, 20′ of the rubber blanket 1′. The rubber blanket 1′ is thus also inserted with thinner end sections 10, 20′ into the groove 34′ as compared to the main section 5.

An insertion aid 7 that is also embodied as a strip 14 is arranged in the groove 34′, between the trailing end section 20′ of the rubber blanket 1′ and a wall 22 of the groove 34′. According to one embodiment, the strip 14 is attached to the trailing end section 20′ and is inserted together with the end section into the groove 34′. This arrangement is particularly easy to assemble because the leading end section 10 can initially be inserted without problems into the groove 34′. To obtain a secure seal for the self-adhering layer 4 against solvents and printing ink, the trailing end section 20′ must be pushed into the groove 34′, thereby causing the end sections 10, 20′ to be elastically deformed. For this, the groove 34′ is embodied with smaller dimensions as compared to the thickness of the end sections 10, 20′ and the strip 14.

To facilitate the insertion of the trailing end section 20′ into the groove 34′, the wall 22 of the groove 34′ or the strip 14 on the side facing the wall 22 can be provided with a gliding layer 6. This gliding layer 6 can be applied to the respective surfaces during a replacement of the rubber blanket 1′. The strip 14 or the wall 22 can alternatively or additionally also be provided with permanent gliding layers 6. These types of gliding layers are composed, for example, of polytetrafluorethylene or another substance having gliding properties. The end sections 10, 20′ of the rubber blanket 1′ may consist at least in part of a metal, plastic or ceramic material, wherein these materials can also have gliding properties.

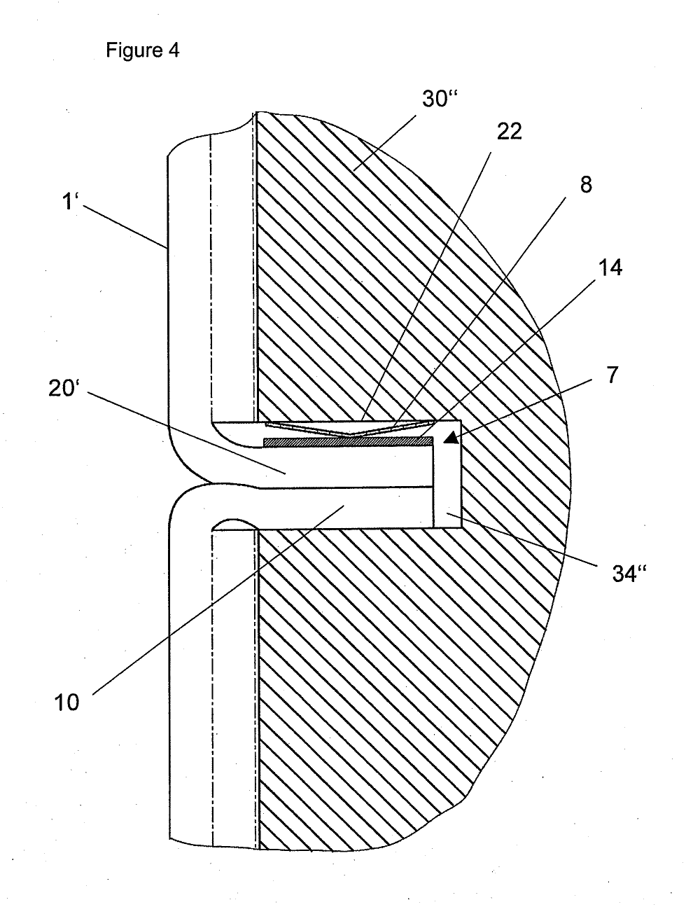

FIG. 4 shows a fourth embodiment with an enlarged detail of a radial section through a print cylinder 30″, comparable to the print cylinder 30′ shown in FIG. 3.

In contrast to the representation shown in FIG. 3, a spring element 8 is provided inside a groove 34″ between the strip 14 and the wall 22. The spring element 8 can itself be deformed and causes an elastic deformation of the end sections 10, 20′ of the rubber blanket 1′ which are inserted into the groove 34″. In addition to the embodiment of a curved sheet metal piece, shown in FIG. 4, one skilled in the art is also familiar with spring elements 8 of this type which have a different shape. For example, it is conceivable to have spiral spring elements which are distributed over the length of the groove 34″ and can also lead to an elastic deformation of the end sections 10, 20′ of the rubber blanket 1′.

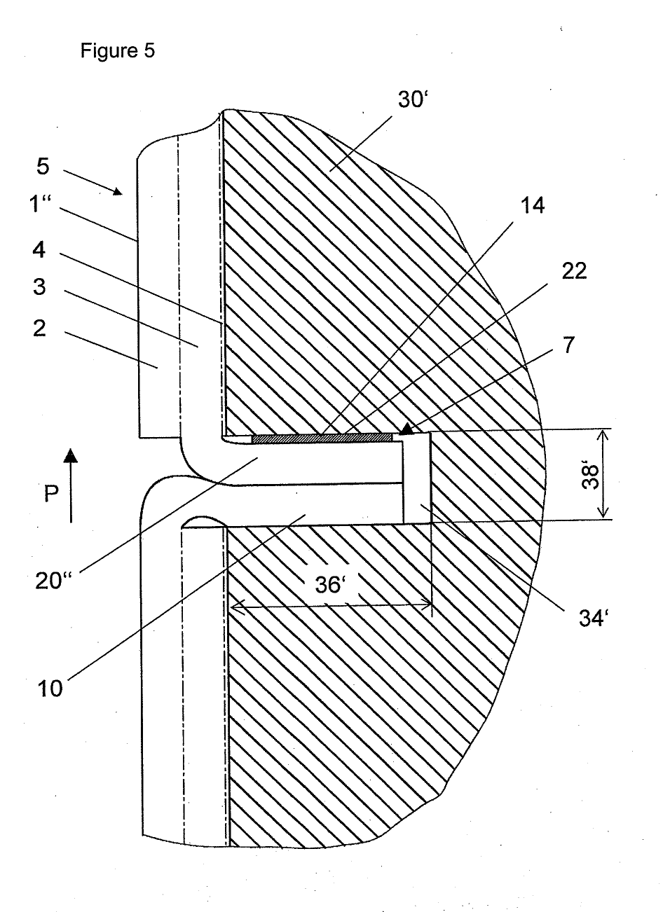

FIG. 5 shows a detail of a radial section for a fifth embodiment. In the same way as for the previous embodiments, the print cylinder 30′ shown herein is also provided on the outer surface with a groove 34′ having a groove width 38′ and a groove depth 36′.

Analog to the preceding embodiments, a rubber blanket 1′ with self-adhering layer 4 is attached to the print cylinder 30′. The main section 5 of the rubber blanket 1″ again contains the standard layer-type composition, meaning a support layer 3 and a cover layer 2 are embodied in addition to the self-adhering layer 4. In contrast to the preceding embodiments, however, the cover layer 2 is removed from the trailing end section 20″. Otherwise, a strip 14 that facilitates the insertion of the trailing end section 20″ is also provided for this embodiment between the wall 22 of the groove 34′ and the trailing end section 20″ of the rubber blanket 1′.

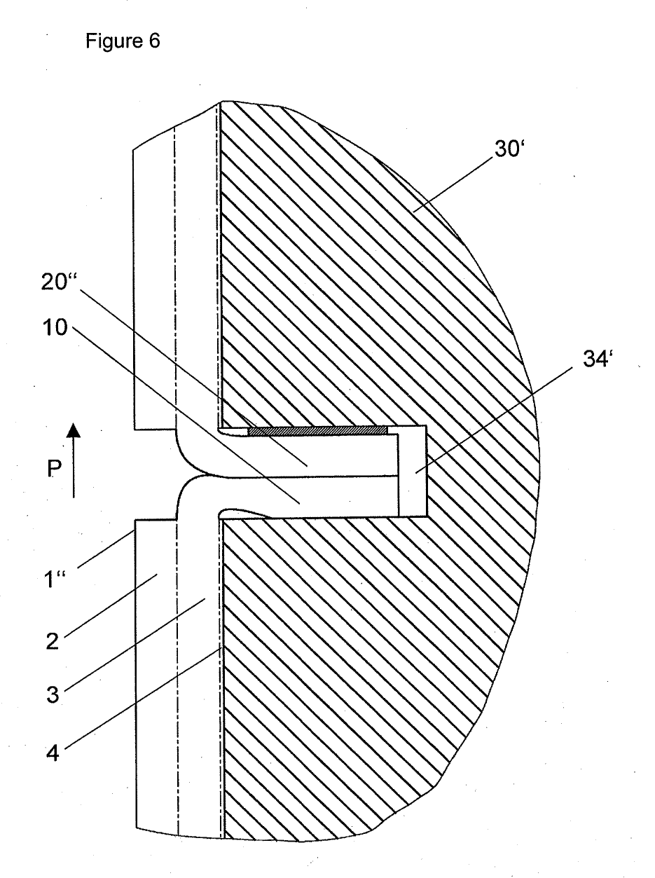

A different embodiment according to FIG. 6 shows the removal of the cover layer 2 from the leading end section as well as the trailing end section 10, 20″ of the rubber blanket 1″, wherein this represents an alternative solution that can be used depending on the configuration of the rotary offset printing press.

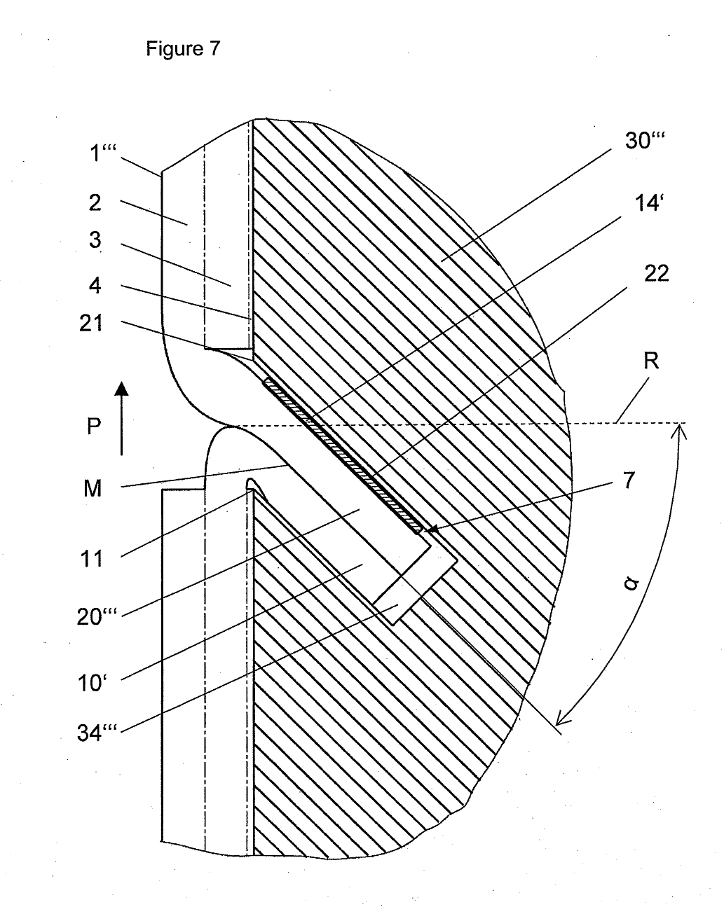

FIG. 7 shows yet another example of a print cylinder 30′″ having a different design as compared to the overall view shown in FIG. 8. The difference to the previously described embodiments is that the groove 34′″ extends radially at an angle toward the inside of the print cylinder 30′″.

A further difference can be found in the removal of layers from the end sections 10′, 20′″ which are inserted into the angled groove 34′″.

For this embodiment, the end section 10′ that leads in production direction P of the print cylinder 30′″ is inserted at an acute angle α into the groove 34′″. To facilitate the insertion of the leading end section 10′ into the angled groove 34′″, the cover layer 2 of the rubber blanket 1′″ is removed past the end section 10′ for the embodiment shown herein, meaning only the support layer and, if applicable, the self-adhering layer 4 are inserted into the groove 34′″.

In general, however, the self-adhering layer 4 always ends at the radial outer edge 11, 21 of the groove 34, 34′, 34″, 34′″, such that the insertion and removal of the respective end section 10, 10′, 20, 20′, 20″, 20′″ of the rubber blanket 1, 1′, 1″, 1′″ is not made difficult.

If the rubber blanket 1′″ for the embodiment shown in FIG. 7 is fitted around the print cylinder 30″″ and is glued to the cylinder, then the trailing end section 20′″ is inserted at an obtuse angle of 90°+α into the groove 34′″.

The trailing end section 20′″ is provided with a strip 14′, facing the wall 22 of the groove 34′″ and facing away from the leading end section 10′ of the rubber blanket 1′″, wherein this strip facilitates the insertion of the trailing end section 20′″.

A center plane M of the groove 34′″ extends parallel to the inserted end sections 10′, 20′″ and occupies an angle α to a radial plane R of the print cylinder 30′″ and intersects with its circumference together with the center plane M of the groove 34′″.

It will be understood that the above description of the present invention is susceptible to various modifications, changes and adaptations, and that the same are intended to be comprehended within the meaning and range of equivalents of the appended claims.

What is claimed is:

1. An apparatus for a rotary offset printing press, comprising:
a print cylinder having a radially inward extending groove; and
a rubber blanket having a main section coupled to the print cylinder, the rubber blanket comprising at least first, second and third layers in the main section, the first layer comprising a self-adhering layer which faces the print cylinder and is adapted to attach the rubber blanket to the print cylinder, and the second and third layers comprising a support layer and a cover layer, respectively, which face away from the print cylinder,
wherein the rubber blanket has a leading end section as seen in a production direction of the print cylinder and a trailing end section as seen in the production direction of the print cylinder, wherein the end sections directly adjoin the main section, and
wherein at least the leading end section of the rubber blanket is inserted into the groove of the print cylinder.

2. The apparatus according to claim 1, wherein the trailing end section of the rubber blanket is also inserted in the groove.

3. The apparatus according to claim 1, wherein at least one of the end sections of the rubber blanket has a reduced number of layers as compared to the main section.

4. The apparatus according to claim 1, further comprising an insertion aid coupled to at least one of the end sections of the rubber blanket, wherein the insertion aid comprises a reinforcing layer on one side of the respective end section and wherein the insertion aid comprises one of a metal, plastic or ceramic material.

5. The apparatus according to claim 1, further comprising a gliding layer coupled to at least one of the end sections of the rubber blanket.

6. The apparatus according to claim 1, wherein at least one of the first, second and third layers of the rubber blanket is removed from at least one of the end sections.

7. The apparatus according to claim 6, wherein the at least one removed layer comprises at least one of the first and second layers of the rubber blanket that face the print cylinder.

8. The apparatus according to claim 6, wherein the at least one removed layer comprises at least one of the second and third layers of the rubber blanket that are positioned away from the print cylinder.

9. The apparatus according to claim 1, wherein the groove has a smaller dimension than at least one end section of the rubber blanket and the at least one end section is securable through elastic deformation inside the groove, such that the at least one end section is removeable.

10. The apparatus according to claim 1, further comprising a strip that is arranged adjacent to at least one of the end sections inside the groove.

11. The apparatus according to claim 10, wherein the strip is arranged between a wall of the groove and one of the end sections of the rubber blanket.

12. The apparatus according to claim 10, wherein the strip comprises an insertion aid that is fixedly connected to the rubber blanket.

13. The apparatus according to claim 1, further comprising at least one spring element arranged adjacent to one of the end sections in the groove.

14. The apparatus according to claim 1, wherein the groove is oriented at an angle relative to a radial plane of the print cylinder which intersects with a center plane of the groove at the circumference of the print cylinder.

15. A rotary offset printing press comprising the apparatus according to claim 1.

16. The apparatus according to claim 5, wherein the gliding layer is applied permanently to the at least one end section.

17. The apparatus according to claim 5, wherein the gliding layer comprises a coating of polytetrafluorethylene or other substance having gliding properties.

18. The apparatus according to claim 1, further comprising a wall of the groove that is adapted to be as resilient as a spring element.

19. The apparatus according to claim 10, wherein the strip comprises an insertion aid embodied as a separate strip from the rubber blanket.
